(19) United States
(12) Patent Application Publication
(10) Pub. No.: US 2024/0313828 A1
(43) Pub. Date: Sep. 19, 2024

(54) ENCRYPTION KEY EXTRACTION USING A RECONFIGURABLE INTELLIGENT SURFACE

(71) Applicant: QUALCOMM Incorporated, San Diego, CA (US)

(72) Inventors: Ahmed ELSHAFIE, San Diego, CA (US); Yu ZHANG, San Diego, CA (US)

(21) Appl. No.: 18/261,658

(22) PCT Filed: Mar. 22, 2021
(86) PCT No.: PCT/CN2021/082112

§ 371 Date: Jul. 14, 2023

(51) Int. Cl. H04B 7/04; H04B 7/0456; H04L 9/08

(52) U.S. Cl. CPC H04B 7/04013; H04B 7/0456; H04L 9/0869

(57) ABSTRACT

Certain aspects of the present disclosure provide techniques for encryption key extraction using a reconfigurable intelligent surface (RIS). A method that may be performed by a first wireless node includes receiving one or more first reference signals (RSS) as reflections off a RIS from a second wireless node. The method also includes generating a key based at least in part on a quantization of the one or more first RSs and communicating, based on the key, with the second wireless node.

### BACKGROUND

### Field of the Disclosure

Aspects of the present disclosure relate to wireless communications, and more particularly, to techniques for encryption key extraction using a reconfigurable intelligent surface (RIS).

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. These improvements should be applicable to other multi-access technologies and the telecommunication standards that employ these technologies.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include secure communications through a reconfigurable intelligent surface (RIS).

Certain aspects of the subject matter described in this disclosure can be implemented in a method for wireless communications by a first wireless node. The method generally includes receiving one or more first reference signals (RSs) as reflections off a RIS from a second wireless node; generating a key based at least in part on a quantization of the one or more first RSs; and communicating, based on the key, with the second wireless node.

Certain aspects of the subject matter described in this disclosure can be implemented in a method for wireless communications by a network entity. The method generally includes receiving one or more RSs indicative of a key from a first wireless node; reflecting the one or more RSs with one or more elements at a RIS to a second wireless node; and reflecting one or more messages encrypted with the key between the first wireless node and the second wireless node.

Certain aspects of the subject matter described in this disclosure can be implemented in a first wireless node. The first wireless node generally includes a transceiver, a memory, and at least one processor. The transceiver is configured to receive one or more first RSs as reflections off a RIS from a second wireless node. The at least one processor is coupled to the memory, and the at least one processor and the memory are configured to generate a key based at least in part on a quantization of the one or more first RSs. The transceiver is configured to communicate, based on the key, with the second wireless node.

Certain aspects of the subject matter described in this disclosure can be implemented in a network entity. The network entity generally includes a RIS controller coupled to a RIS. The RIS controller and the RIS are configured to receive one or more RSs indicative of a key from a first wireless node; reflect the one or more RSs with one or more elements at the RIS to a second wireless node; and reflect one or more messages encrypted with the key between the first wireless node and the second wireless node.

Certain aspects of the subject matter described in this disclosure can be implemented in an apparatus for wireless communications by a first wireless node. The apparatus generally includes an interface configured to obtain one or more first reference signals (RSs) as reflections off a RIS from a second wireless node; and a processing system configured to generate a key based at least in part on a quantization of the one or more first RSs and communicate, based on the key, with the second wireless node.

Certain aspects of the subject matter described in this disclosure can be implemented in an apparatus for wireless communications by a network entity. The apparatus generally includes an interface configured to obtain one or more RSs indicative of a key from a first wireless node; and a processing system configured to reflect the one or more RSs with one or more elements at a RIS to a second wireless node and reflect one or more messages encrypted with the key between the first wireless node and the second wireless node

Certain aspects of the subject matter described in this disclosure can be implemented in a first wireless node. The first wireless node generally includes means for receiving one or more first RSs as reflections off a RIS from a second wireless node; means for generating a key based at least in part on a quantization of the one or more first RSs; and means for communicating, based on the key, with the second wireless node.

Certain aspects of the subject matter described in this disclosure can be implemented in a network entity. The network entity generally includes means for receiving one or more RSs indicative of a key from a first wireless node; means for reflecting the one or more RSs with one or more elements at a RIS to a second wireless node; and means for reflecting one or more messages encrypted with the key between the first wireless node and the second wireless node.

Certain aspects of the subject matter described in this disclosure can be implemented in a computer-readable medium for wireless communications. The computer-readable medium generally having instructions or codes executable by an apparatus for obtaining one or more first RSs as reflections off a reconfigurable intelligent surface (RIS) from a second wireless node; generating a key based at least in part on a quantization of the one or more first RSs; and communicating, based on the key, with the second wireless node

Certain aspects of the subject matter described in this disclosure can be implemented in a computer-readable medium for wireless communications. The computer-readable medium generally having instructions or codes executable by an apparatus for obtaining one or more RSs indicative of a key from a first wireless node; reflecting the one or more RSs with one or more elements at a RIS to a second wireless node; and reflecting one or more messages encrypted with the key between the first wireless node and the second wireless node.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4A illustrates an example of communication blockage between wireless communication devices.

FIG. 4B illustrates an example of using a reconfigurable intelligent surface (RIS) to overcome the blockage depicted in FIG. 4B, according with certain aspects of the present disclosure.

FIG. 5 is a flow diagram illustrating example operations for wireless communication by a wireless node (e.g., a UE or BS), in accordance with certain aspects of the present disclosure.

FIG. 6 is a flow diagram illustrating example operations for wireless communication by a network entity (e.g., a RIS controller), in accordance with certain aspects of the present disclosure.

FIG. 7A is a diagram illustrating an example wireless communication system employing one or more RISs, in accordance with certain aspects of the present disclosure.

FIG. 7B is a diagram illustrating a sequence of clusters over time, in accordance with certain aspects of the present disclosure.

FIG. 8 is a signaling flow diagram illustrating example signaling for encryption key extraction, in accordance with certain aspects of the present disclosure.

FIG. 9 illustrates a communications device (e.g., a UE or BS) that may include various components configured to perform operations for the techniques disclosed herein in accordance with aspects of the present disclosure.

FIG. 10 illustrates a communications device (e.g., a RIS controller) that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide wireless nodes, network entities, apparatuses, methods, processing systems, and computer readable mediums for sharing an encryption key through a reconfigurable intelligent surface (RIS). The techniques for sharing an encryption key described herein may enable confidential communications through a RIS between a base station and user equipment (UE) and/or between UEs, for example, at a physical layer of a protocol stack.

The following description provides examples of RIS-enabled communications in communication systems. Changes may be made in the function and arrangement of elements discussed without departing from the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QOS) requirements. In addition, these services may co-exist in the same subframe.

NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

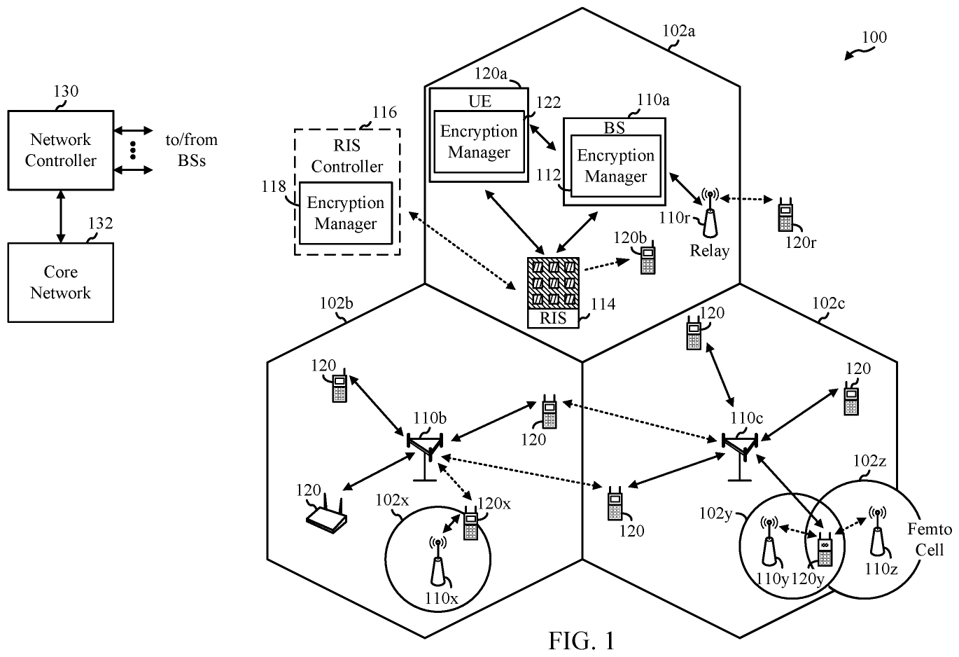

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110a-z (each also individually referred to herein as BS 110 or collectively as BSs 110) and/or user equipment (UE) 120a-y (each also individually referred to herein as UE 120 or collectively as UEs 120) in the wireless communication network 100 via one or more interfaces.

In certain aspects, the BS 110a (e.g., gNB) and the UE 120a may communicate through a reconfigurable intelligent surface (RIS) 114, for example, when a line-of-sight path between the BS 110a (e.g., gNB) and the UE 120a is obstructed by an obstacle or when the channel capacity or channel quality in the line-of-sight path is relatively low. For example, the RIS 114 may generate a codebook for precoding one or more elements (e.g., antenna elements) thereon (referred to as RIS elements) to allow a beam from the BS 110a (e.g., a transmitter) to be re-radiated off the RIS 114 to reach the UE 120a (e.g., a receiver), or vice versa. A RIS controller 116 may control or reconfigure the spatial direction of the re-radiation (e.g., the beamforming) at the RIS 114. While the RIS controller 116 is depicted as a separate network entity in communication with the RIS 114 to facilitate understanding, aspects of the present disclosure may be applied to the RIS controller 116 being integrated or co-located with the BS 110a, RIS 114, UE 120a, and/or network controller 130.

The BS 110a includes an encryption manager 112 that may share an encryption key with a UE using the channel properties between the BS and the UE through the RIS 114 as a technique for randomizing the encryption key, in accordance with aspects of the present disclosure. The UE 120a includes an encryption manager 122 that may generate an encryption key based at least in part on a quantization of signals received from the BS, in accordance with aspects of the present disclosure. The RIS controller 116 includes an encryption manager 118 that uses specific elements of the RIS 114 for reflecting the signals during the encryption key extraction phase, in accordance with certain aspects of the present disclosure. The encryption key may enable the BS 110a and UE 120a to communicate securely without a potential eavesdropper (e.g., the UE 120b) listening in on the communications, which may reflect off of the RIS 114.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In certain cases, the network controller 130 may include a centralized unit (CU) and/or a distributed unit (DU), for example, in a 5G NR system. In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

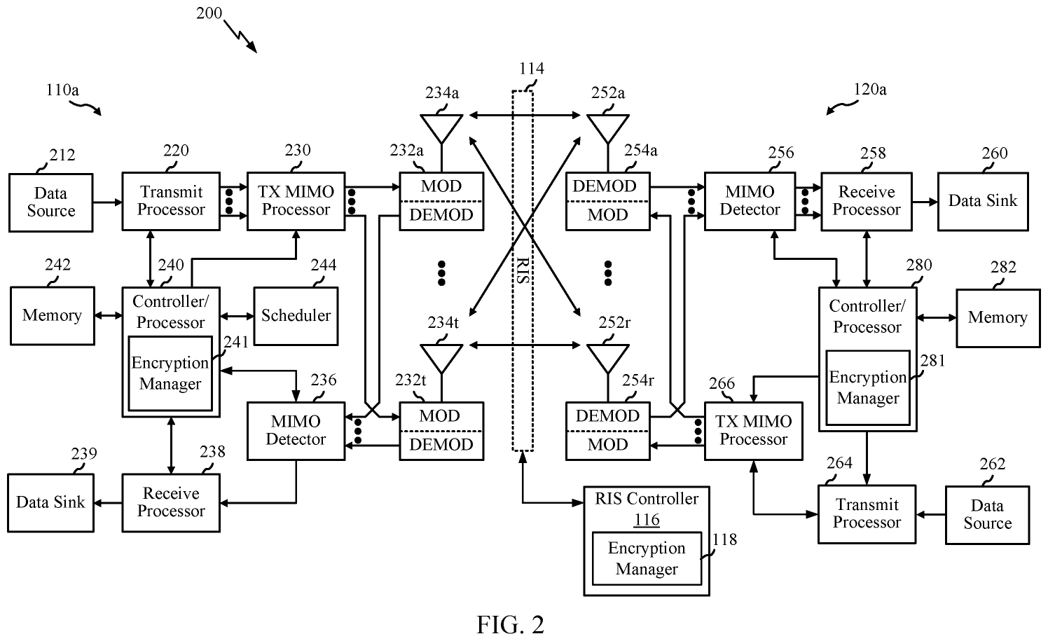

FIG. 2 illustrates example components of BS 110a and UE 120a (e.g., the wireless communication network 100 of FIG. 1), which may be used to implement aspects of the present disclosure. As shown, the RIS 114 may assist the communications, by receiving and re-radiate radio signals, between the BS 110 and UE 120. For example, the RIS 114 may re-radiate the transmissions from one of the BS 110 or UE 120 to the other using reflection, refraction, or other passive or active mechanisms.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has an encryption manager 241 that may share an encryption key with a UE using the channel properties between the BS and the UE through the RIS 114 as a technique for randomizing the encryption key at the UE, according to aspects described herein. As shown in FIG. 2, the controller/processor 280 of the UE 120a has an encryption manager 281 that may generate an encryption key based at least in part on a quantization of signals received from the BS, according to aspects described herein. Although shown at the controller/processor, other components of the UE 120a and BS 110a may be used to perform the operations described herein.

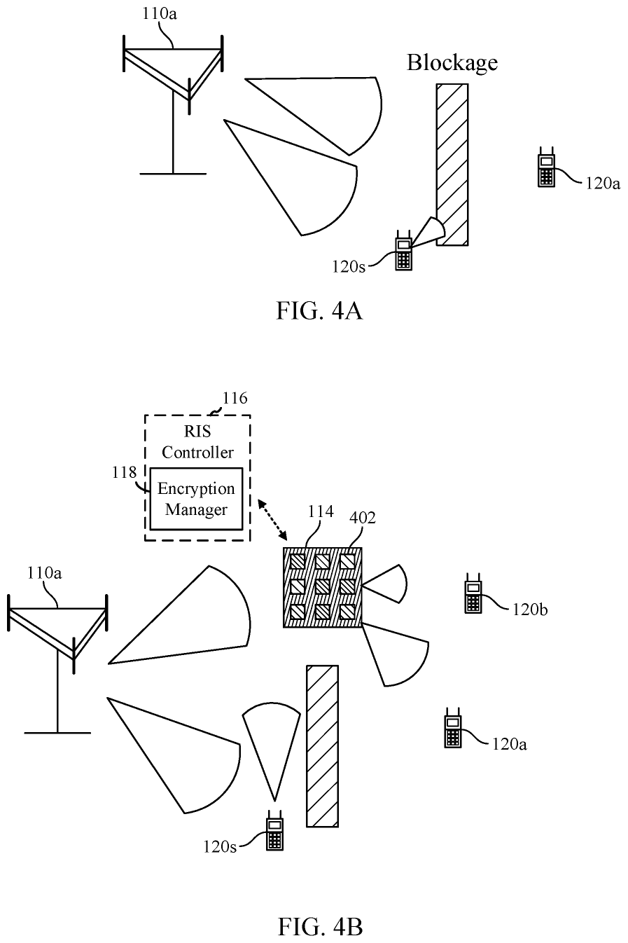

The RIS 114 may be configured or controlled by the RIS controller 116. RIS elements may re-radiate radio signals between the UE and BS with certain phase shifts or amplitude changes as controlled by the RIS controller 116. The RIS controller 116 may reconfigure the phase or amplitude changes by applying a precoding weight to RIS elements to enable the RIS 114 to re-radiate an output beam at different directions given a particular input beam. An illustrative deployment example of the RIS 114 is shown in FIG. 4B. According to the present disclosure, the RIS controller 116 includes an encryption manager that uses specific RIS elements for encryption key extraction between the BS and UE, in accordance with aspects described herein.

While the UE 120a is described with respect to FIGS. 1 and 2 as communicating with a BS and/or within a network, the UE 120a may be configured to communicate directly with/transmit directly to another UE 120, or with/to another wireless device (such as the RIS 114) without relaying communications through a network. In some embodiments, the BS 110a illustrated in FIG. 2 and described above is an example of another UE 120.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

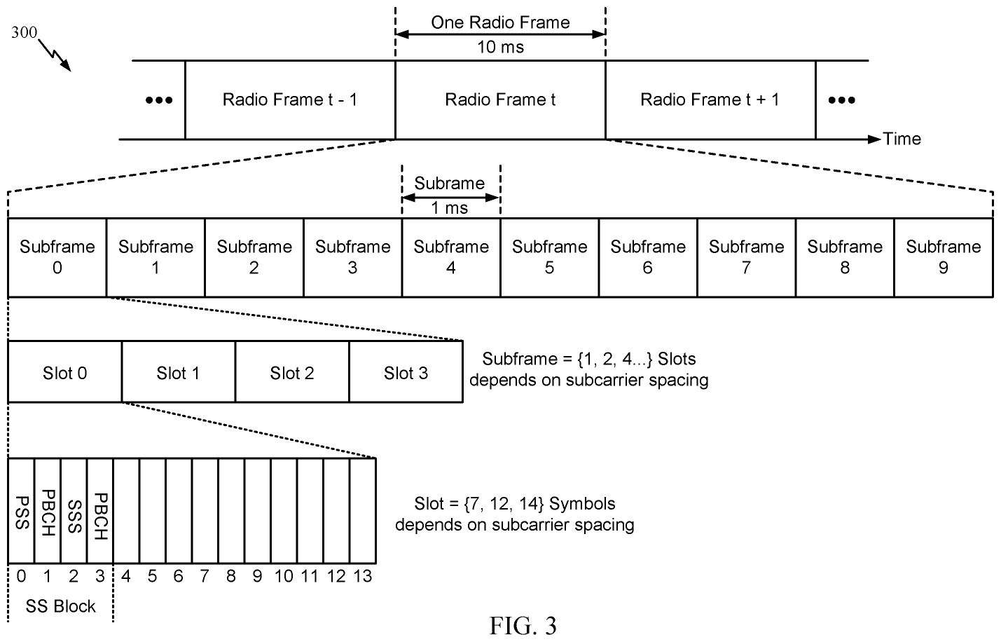

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure may refer to a transmit time interval having a duration less than a slot (e.g., 2, 3, or 4 symbols). Each symbol in a slot may be configured for a link direction (e.g., downlink (DL), uplink (UL), or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst periodicity, system frame number, etc. The SSBs may be organized into an SS burst to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times within an SS burst, for example, with up to sixty-four different beam directions for mmWave. The multiple transmissions of the SSB are referred to as an SS burst in a half radio frame. SSBs in an SS burst may be transmitted in the same frequency region, while SSBs in different SS bursts can be transmitted at different frequency regions.

As discussed above, massive multiple input multiple output (MIMO) configuration increases throughput. For example, MIMO can achieve high beamforming gain by using active antenna units and can operate with individual radio frequency (RF) chains for each antenna port. To further such advantages and extend coverage, RISs may be deployed to reflect impinging waves in desired directions. In some cases, RISs may operate without substantial power consumption when they operate passively to only reflect or refract beams from a transmitter toward a receiver. In some cases, the reflection or refraction direction may be controlled by a base station, network controller, or a UE (e.g., a sidelink monitoring UE).

FIG. 4A illustrates an example of communication blockage (such as building, tree, or other obstruction) between wireless communication devices. As shown, the BS 110a may only be able to wirelessly communicate with the UE 120s, and transmissions from the BS 110a may not reach the UE 120a, for example, due to the blockage preventing signals from reaching the UE 120a. The blockage may also prevent the UE 120s from establishing sidelink communications with the UE 120a.

FIG. 4B illustrates an example of using a RIS (such as the RIS 114 of FIGS. 1 and 2) to overcome the blockage, according with certain aspects of the present disclosure. As shown, a RIS 114 may be arranged to reflect or otherwise re-radiate the radio signals from the BS 110a to bypass the blockage. For example, the two-way communications between the BS 110a and the UE 120a may be enabled by the RIS 114 re-radiating one or more beams from the BS 110a toward the UE 120a, or vice versa. Furthermore, the RIS 114 can also be configured (i.e., directing incoming and outgoing beams at different angles) to enable the UEs 120s and 120a to communicate via sidelink channels, for example, around the blockage.

The RIS 114 may perform passive beamforming. For example, the RIS 114 may receive signal power from the transmitter (e.g., the BS 110a, UE 120a, or UE 120s) proportional to a number of RIS elements 402 thereon. When the RIS reflects or refracts the radio signal, the RIS elements 402 cause phase shifts to perform conventional beamforming or precoding. The phase shifts may be controlled by precoding weights (e.g., a multiplier or an offset of time delay) applied to the RIS elements. For an array of RIS elements, such as an m×n rectangular matrix, for example, a respective precoding weight may be generated or specified for each of the RIS element by the RIS controller. In certain aspects, the RIS 114 may be implemented as a reflectarray with a passive antenna array, such that the RIS element 402 may be implemented as an antenna coupled to a phase shifter. In certain aspects, the RIS 114 may be implemented with metasurfaces, such that the RIS element 402 may be implemented as a reconfigurable metasurface that can impose an amplitude and/or phase profile on an incident RF signal.

While the example depicted in FIG. 4B is described herein with respect to the RIS enabling wireless communications around a blockage to facilitate understanding, aspects of the present disclosure may also be applied to other suitable applications for wirelessly communicating through a RIS such as providing alternative or additional spatial capacity for wireless communications.

In certain cases, another UE 120b may be in the coverage area of reflections from the RIS 114. The other UE 120b may be capable of eavesdropping on the communications between the BS 110a and the UE 120a and/or the UE 120s and the UE 120a. Without suitable encryption, the other UE 120b may be able to intercept reflections from the RIS 114 intended for a different UE or BS and decode those reflections, which may compromise the expected level of security for the communications between the BS 110a and the UE 120a and/or the UE 120s and the UE 120a.

### Example Encryption Key Extraction Using a Reconfigurable Intelligent Surface

Aspects of the present disclosure provide apparatus and techniques for extracting an encryption key from communications through a RIS. Given the presence of the RIS, the wireless communication system can exploit the many elements used per RIS to select, or use, some elements for efficiently randomizing the channel at an eavesdropper and generate a key for the legitimate TX-RX pair, such as a BS-UE pair and/or a UE-UE pair.

As an example, a BS may transmit a first reference signal to the RIS, which reflects the first reference signal a UE. The UE may generate a key based on a quantization of the reflected first reference signal. In certain cases, the UE may send a second reference signal to the RIS, which reflects the second reference signal to the BS. The BS may generate an estimate of the channel through the RIS to the UE based on the channel reciprocity and measurements of the reflected second reference signal. With the channel estimate, the BS may derive the key obtained at the UE from the first reference signal. The BS and UE may use the key to encrypt and/or decrypt messages exchanged, for example, at the physical layer. The unique channel properties for the BS-RIS-UE channel may facilitate key generation at the UE and/or BS, and given channel reciprocity, the BS may be able derive the key generated at the UE, for example, based on a model of the BS-RIS-UE channel. At a high signal-to-noise (SNR) transmissions, any mismatch between the two quantized versions of the key will be very low to facilitate key agreement between the BS and UE. In this example, the BS and UE share a secret key (i.e., symmetric encryption), which may be used to encrypt and decrypt messages. Aspects of the present disclosure may also apply to the BS and UE sharing a public key in a public-private pair (i.e., asymmetric encryption) and/or the BS and UE sharing a secret key encrypted with a public key (i.e., a hybrid cryptosystem).

The encryption key extraction described herein may enable confidential communications through a RIS between a BS and UE and/or between UEs, for example, at the physical layer of a protocol stack. For example, a BS and/or UE may be able to securely encrypt physical layer messages (e.g., downlink control information (DCI), uplink control information (UCI), radio resource control (RRC) messages, medium access control (MAC) messages, and/or sidelink control information (SCI)) and/or channels (e.g., physical sidelink shared channel (PSSCH), physical sidelink feedback channel (PSFCH), physical sidelink control channel (PSCCH), physical downlink shared channel (PDSCH), physical uplink shared channel (PUSCH)) using the encryption key derived from the methods described herein.

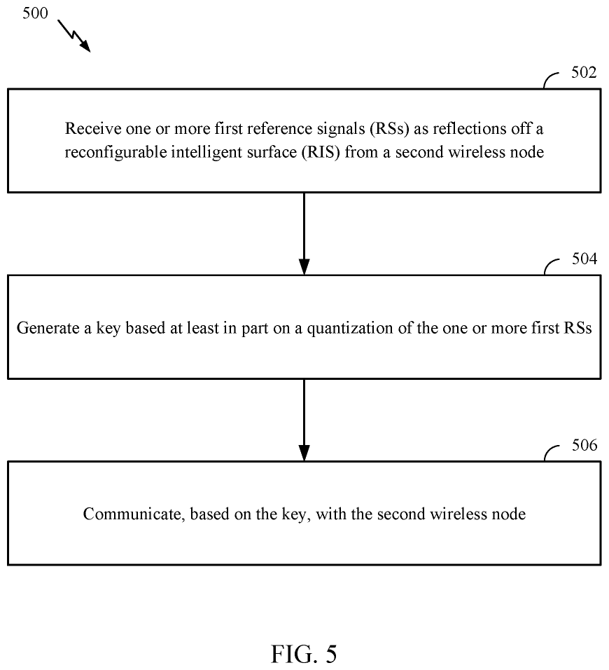

FIG. 5 is a flow diagram illustrating example operations 500 for wireless communication, in accordance with certain aspects of the present disclosure. The operations 500 may be performed, for example, by a first wireless node (such as the UE 120a and/or BS 110a in the wireless communication network 100). The operations 500 may be implemented as software components that are executed and run on one or more processors (e.g., controller/processor 280 and/or controller/processor 240 of FIG. 2). Further, the transmission and reception of signals by the UE in operations 500 may be enabled, for example, by one or more antennas (e.g., antennas 252 and/or antennas 234 of FIG. 2). In certain aspects, the transmission and/or reception of signals by the UE may be implemented via a bus interface of one or more processors (e.g., controller/processor 280 and/or controller/processor 240) obtaining and/or outputting signals. As used herein, a wireless node may refer to a wireless communication device such as a UE and/or BS.

The operations 500 may begin, at block 502, where the first wireless node may receive one or more first reference signals (RSS) as reflections off a RIS (e.g., the RIS 114) from a second wireless node (e.g., the BS 110a or UE 120s). In UE-UE communications, the first wireless node may be the UE 120a, and the second wireless node may be the UE 120s depicted in FIG. 4B. In BS-UE communications, the first wireless node may be the UE 120a, and the second wireless node may be the BS 110a depicted in FIG. 4B, or vice versa. As used herein, reflections may include a signal that is re-radiated from the RIS, for example, by a reflectarray. In aspects, the first RSs may include a synchronization signal (such as a PSS or SSS in an SSB), a CSI-RS, and/or a DMRS.

At block 504, the first wireless node may generate a key based at least in part on a quantization of the one or more first RSs. For example, the first wireless node may quantize a portion of the first RSs at one or more levels of quantization, which may be configured by the second wireless node. That is, the first wireless node may convert a portion of the first RSs to a specific data value, such as a string value and/or number value, and the data value may serve as the key or a seed for generating the key, for example, using a pseudorandom number generator. In certain cases, the first wireless node may quantize multiple portions of the first RSs to generate multiple data values, which may be used to generate the key, for example, through concatenation and/or a pseudorandom number generator. As an example, the first wireless node may concatenate the multiple data values together and use the concatenated data values as the seed for a pseudorandom generator to generate the key.

At block 506, the first wireless node may communicate, based on the key, with the second wireless node. For example, the first wireless node may encrypt messages using the key and transmit those encrypted messages to the second wireless node. The first wireless node may receive encrypted messages from the second wireless and decrypt those messages using the key.

In certain aspects, the first wireless node may also transmit a reference signal (e.g., a sounding reference signal (SRS) and/or DMRS) to the second wireless node, for example, to facilitate channel estimation and/or key quantization at the second wireless node. With respect to the operations 500, the first wireless node may transmit, to the second wireless node, one or more second RSs as reflections off of the RIS. In certain aspects, the second wireless node may generate an estimate of the channel between the first wireless node and the second wireless node through the RIS based on measurements of the second RSs. With the channel estimate, the second wireless node may derive the key obtained at the first wireless node, and the second wireless node may use the key for decrypting messages from the first wireless node and/or encrypting messages to the first wireless node. The second wireless node may derive the key obtained at the first wireless node by transforming the first RSs to the received signals at the first wireless node using the estimate of the channel through the RIS.

For certain aspects, the second wireless node may generate another key based at least in part on a quantization of the second RSs. For example, the other key may be a separate secret key from the key generated at block 504 or a separate public key for encrypting messages to the first wireless node.

In aspects, the first wireless node may configure the RIS for key extraction. For example, the first wireless node may configure the RIS to user certain elements and/or a certain precoder (e.g., beamforming configuration) during the key extraction phase (e.g., key sharing between wireless nodes). The RIS configuration, which may be specific to the key extraction phase, may further facilitate randomization of the received signal at the first wireless node and/or the second wireless node. The randomization may also be encountered at a potential eavesdropper (e.g., the other UE 120b in FIG. 4B) making it difficult for the eavesdropper to reconstruct or prevent the eavesdropper from reconstructing the received signal at the first wireless node and/or second wireless node. With respect to the operations 500, the first wireless node may transmit, to a controller (e.g., the RIS controller 116) associated with the RIS, an indication of one or more elements (e.g., the element 402) at the RIS to use for reflecting at least one of the one or more first RSs or the one or more second RSs. The RIS elements may be indicated in terms of one or more clusters of elements or at an element basis. In certain cases, the indication may further indicate to use the one or more elements at the RIS with one or more specific channels, such as the PSSCH, PSFCH, PSCCH, PDSCH, and/or PUSCH.

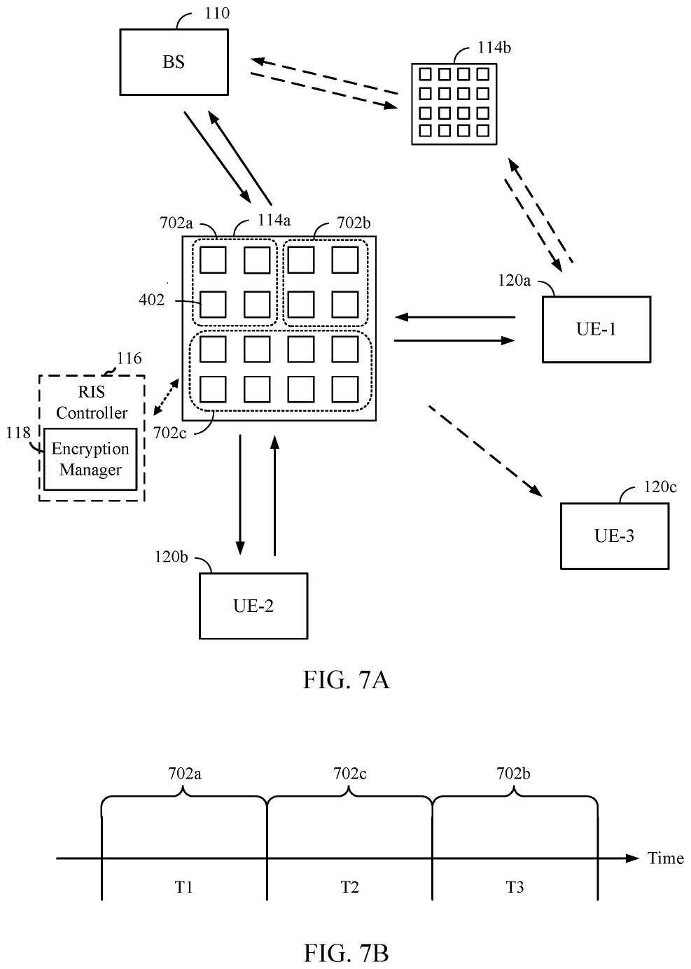

In certain aspects, the first wireless node may signal a sequence of RIS element cluster pattern to be used at a symbol (or min-slot, slot, half frame) level to increase the randomization or confusion at the eavesdropper. With respect to the operations 500, the first wireless node may transmit, to a controller associated with the RIS, an indication of a sequence of elements at the RIS to use over time for reflecting at least one of the one or more first RSs or the one or more second RSs. For example, the first wireless node may indicate a first cluster of elements at a first transmission occasion (e.g., a symbol or sequence of symbols) and a second cluster of elements at a second transmission occasion (e.g., a subsequent symbol or sequence of symbols). In aspects, the sequence of elements may include a sequence of element clusters to use over time at a symbol level, where each of the element clusters comprises a plurality of elements at the RIS, for example, as further described herein with respect to FIG. 7A.

In aspects, the first wireless node may indicate the particular elements at the RIS to use for reflecting the signals via a bitmap. The indication of the sequence of clusters and/or the indication of the elements may include a bitmap associated with the elements at the RIS, where the bitmap may indicate which elements are enabled and/or disabled for reflecting. Assuming there is an array of one by N (1×N) elements (just one dimension for Y-axis), a bitmap with N elements (e.g., N=11) can be used to indicate to the RIS to activate certain elements. For example, suppose the bitmap is set to the following: 1, 0, 0, 0, 0, 0, 1, 0, 0, 0, 1; in such a case, elements 1, 7, and 11 are indicated as being enabled, and the RIS will use those elements to reflect the signal. For a two-dimensional RIS surface, a bitmap matrix may be signaled to indicate which elements are enabled and/or disabled in two dimensions, for example, where “1” may indicate that the RIS element is enabled (i.e., on) and “0” may indicate that the RIS element is disabled (i.e., off). In other words, the bitmap may further indicate which elements are enabled and/or disabled in one or two dimensions across the RIS. In certain aspects, the bitmap may indicate which cluster of elements are disabled and/or enabled. That is, each index of the bitmap may be associated with a particular cluster of elements arranged in the RIS, for example, as further described herein with respect FIG. 7A.

For certain aspects, the first wireless node may indicate a precoding (e.g., beamforming) for the RIS to use for reflecting or re-radiating the signals. With respect to the operations 500, the first wireless node may transmit, to a controller associated with the RIS, an indication of a precoding to use at the RIS for reflecting at least one of the first RSs or the second RSs. In aspects, the precoding indicated may be a precoding matrix and/or precoding weights (e.g., scale factors and/or phase shifter weights) to use for re-radiating the RSs in a particular spatial direction during the key extraction phase.

In certain aspects, the indications signaled to the RIS controller described herein may also be signaled from the first wireless node to the second wireless node. That is, the first wireless node may make the second wireless node aware of the cluster/element selection, cluster/element sequence selection, and/or precoding selection. For certain aspects, the indications signaled to the RIS controller described herein may be signaled from the second wireless node in addition or alternative to the first wireless node signaling such indication(s).

In certain aspects, messages (e.g., the cluster/element indication, cluster/element sequence indication, and/or precoding indication) between the first and second wireless nodes may be encrypted using a previously generated encryption key. For example, the DCI and/or SCI used for signaling the ON/OFF pattern to the RIS controller, UE, and/or BS may be encrypted using a key that was agreed and generated, for example, using the key extraction methods described herein. In certain aspects, an upper protocol layer may handle security of the signaling such that relying on other cryptographic schemes, the pattern of on/off elements at the RIS is secured. The knowledge of this info (which cluster is used or the pattern of clusters) at the eavesdropper does not compromise the security, and the quantization for key extraction is obtained fully secured from the fact that the eavesdropper(s) cannot estimate the channels at UE and/or BS. With respect to the operations 500, the first wireless node may communicate, before generating the key, with the second wireless node via one or more messages encrypted with another key. The messages may include at least one of an indication of elements at the RIS that will be used for reflecting or a level of quantization for generating the key.

In aspects, the RIS controller may configure the RIS for key extraction. For example, the RIS controller may select the elements, the sequence of elements over time, and/or a precoder to use for reflecting the signals. With respect to the operations 500, the first wireless node may receive the first RSs, at block 502, based on a first precoding applied at the RIS. The first wireless node may transmit the second RSs based on a second precoding applied at the RIS, where the second precoding may be the same precoding as or a different precoding than the first precoding. At least one of the first precoding or the second precoding may be selected by a controller associated with the RIS.

For certain aspects, multiple RISs can be used key generation. That is, the multiple RISs may reflect or re-radiate the signals used for key generation and/or channel estimation. The first and second wireless nodes may make sure that the participating RISs will deliver the signal at the receiver as adjusted and agreed. The RIS selection for key generation may be indicated by the first wireless node and/or second wireless node. For example, the first wireless node may transmit, to a controller associated with each of the RISs (which may be one or more controllers), an indication of which RISs are enabled and/or disabled for reflecting the signals during the key extraction phase.

With respect to the operations 500, the RIS may include a plurality of RISs, and the first wireless node may receive the first RSs, at block 502, as the reflections off the plurality of RISs. For example, the first wireless node may receive a portion of the first RSs as reflections off a first RIS at a first transmission occasion (e.g., one or more symbols) and receive another portion of the first RSs as reflections off a second RIS at a second transmission occasion (e.g., one or more subsequent symbols). The first wireless node may transmit the second RSs as the reflections off the plurality of RISs. For example, the first wireless node may transmit a portion of the first RSs as reflections off the first RIS at a first transmission occasion (e.g., one or more symbols) and transmit another portion of the first RSs as reflections off the second RIS at a second transmission occasion (e.g., one or more subsequent symbols).

In certain aspects, the first wireless node may send an acknowledgement (ACK) message to the second wireless node to enable the second wireless node to verify whether the key has been successfully obtained at the first wireless node or acknowledge receipt of the key at the first wireless node. For example, the first wireless node may send an ACK message (such as 1 bit-ACK) scrambled by the key to the second wireless node to acknowledge the reception of the key. That is, the first wireless node may transmit, to the second wireless node, an acknowledgement encrypted with the key.

In certain aspects, the key may be generated using a random number generator, such as pseudorandom number generator (PRNG) or other suitable number generator. At block 504, the first wireless node may generate the key with a random number generator (e.g., a PRNG), where a seed for the random number generator may include the quantization of the first RSs. In aspects, the seed may include multiple quantizations such as multiple data values quantized from the first RSs.

In certain aspects, the key may be a secret key for symmetric encryption or a public key in a public-private pair for asymmetric encryption. With respect to the operations 500, the first wireless node may encrypt one or more messages with the key (e.g., a secret or a public key), and at block 506, the first wireless node may transmit, to the second wireless node, the encrypted messages. At block 506, the first wireless node may receive, from the second wireless node, one or more messages, and the first wireless node may decrypt the messages with the key (as the secret key) or another key associated with the key, where the other key may be a private key in the public-private key pair.

In aspects, the encryption enabled by the key may be at the physical layer in a protocol stack. For example, physical layer messages (such as DCI, SCI, and/or UCI) may be encrypted with the key and/or decrypted with the key or a private key associated with the key. In certain aspects, physical layer channels (e.g., PSSCH, PSFCH, PSCCH, PDSCH, and/or PUSCH) may be encrypted with the key and/or decrypted with the key or a private key associated with the key. With respect to the operations 500, the first wireless node may encrypt and/or decrypt at least one of a downlink channel, an uplink channel, or a sidelink channel with the key. For user-plane traffic, the protocol stack may include a Service Data Adaptation Protocol (SDAP) layer, a Packet Data Convergence Protocol (PDCP) layer, a Radio Link Control (RLC) layer, a Medium Access Control (MAC) layer, and a Physical (PHY) layer. For control-plane traffic, the protocol stack may include a Non-Access Stratum (NAS) layer, a Radio Resource Control (RRC) layer, the PDCP layer, the RLC layer, the MAC layer, and the PHY layer. The PHY layer may provide the transmission waveform (e.g., an OFDM using a cyclic prefix) for user-plane or control-plane traffic via over the air resources (e.g., time-domain resources, frequency-domain resources, and/or spatial domain) between a UE and BS and/or between UEs.

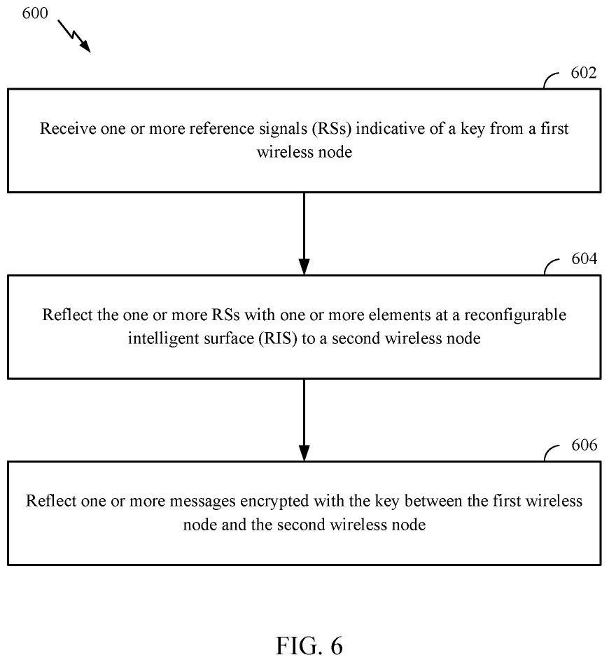

FIG. 6 is a flow diagram illustrating example operations 600 for wireless communication, in accordance with certain aspects of the present disclosure. The operations 600 may be performed, for example, by a network entity (such as the RIS controller 116 in the wireless communication network 100). The operations 600 may be complementary to the operations 500 performed by the wireless node. The operations 600 may be implemented as software components that are executed and run on one or more processors (e.g., the RIS controller 116 of FIG. 2). Further, the transmission and reception of signals by the network entity in operations 600 may be enabled, for example, by a RIS (e.g., the RIS 114 of FIG. 2). In certain aspects, the transmission and/or reception of signals by the network entity may be implemented via a bus interface of one or more processors (e.g., the RIS controller 116 of FIG. 2) obtaining and/or outputting signals. As used herein, the network entity may include a communication device in control of a RIS, such as a RIS controller, a base station, network controller, and/or UE.

The operations 600 may begin, at block 602, where the network entity may receive one or more RSs indicative of a key (e.g., an encryption key such as a secret key or public key) from a first wireless node (e.g., the UE 120a or the BS 110a). For example, referring to FIG. 4B, the RIS controller 116 may receive RSs from the BS 110a via the RIS 114.

At block 604, the network entity may reflect the one or more RSs with one or more elements (e.g., the element 402) at a RIS (e.g., the RIS 114) to a second wireless node (e.g., the BS 110a or the UE 120s). For example, the RIS controller 116 may reflect the RSs with elements 402 at the RIS 114 to the UE 120a according to a specific element sequence and/or precoding for the key extraction phase. In certain aspects, the network entity may receive other RSs from the second wireless node with the RIS, and the network entity may reflect the other RSs to the first wireless node using the same reflection configuration (e.g., elements, element sequence, and/or precoding) used at block 604. Using the same reflection configuration may enable the first wireless node to estimate a channel model for reconstructing the key obtained by the second wireless node, as described herein with respect to the operations 500.

At block 606, the network entity may reflect one or more messages encrypted with the key between the first wireless node and the second wireless node. The network entity may reflect the messages with the elements at the RIS, for example, as described herein with respect to FIG. 4B. As an example, the first wireless node may transmit an encrypted message to the RIS, which reflects and/or re-radiates the encrypted messages to the second wireless node, or vice versa.

In aspects, the first wireless node or second wireless node may configure the RIS for reflecting the signals during the key extraction phase, for example, as described herein with respect to the operations 500. The network entity may receive, from the first wireless node or the second wireless node, an indication of the one or more elements at the RIS to use for reflecting the one or more RSs. The indication may further indicate to use the one or more elements at the RIS with one or more specific channels. In certain aspects, the network entity may receive, from the first wireless node or the second wireless node, an indication of a sequence of elements at the RIS to use over time for reflecting the one or more RSs, and the network entity may reflect the RSs according to the sequence of elements at the RIS. For example, the network entity may reflect a portion of the RSs using a first cluster of elements at a first transmission occasion (e.g., a symbol or sequence of symbols) and second portion of the RSs using a second cluster of elements at a second transmission occasion (e.g., a subsequent symbol or sequence of symbols). For certain aspects, the indication of the elements enabled for reflecting may be indicated via bitmap, for example, as described herein with respect to the operations 500. In certain aspects, the network entity may receive, from the first wireless node or the second wireless node, an indication of a precoding (e.g., beamforming) to use at the RIS for reflecting the one or more RSs, and the network entity may reflect the RSs based on the indicated precoding.

For certain aspects, the network entity may configure the RIS for reflecting the signals during key extraction phase, for example, as described herein with respect to the operations 500. The network entity may select a configuration (e.g., a precoding, a cluster of elements, a sequence of precodings, and/or a sequence of clusters) for the reflection of the RSs, and the network entity may reflect the RSs based on the selected configuration (e.g., a selected precoding).

In aspects, multiple RISs may be used to reflect the RSs, for example, as described herein with respect to the operations 500. The network entity may receive the RSs at a plurality of RISs, and the network entity may reflect the RSs with the elements at the plurality of RISs.

FIG. 7A is a diagram illustrating an example wireless communication system employing one or more RISs 114a, 114b, in accordance with certain aspects of the present disclosure. As shown, the first RIS 114a may be configured with a set of clusters 702a, 702b, 702c (collectively clusters 702), where each of the clusters 702 may include one or more elements 402. In this example, the first cluster 702a includes four elements 402 arranged in a two-by-two matrix; the second cluster 702b is arranged adjacent to the first cluster 702a and includes four elements 402 arranged in a two-by-two matrix; and the third cluster 702c is arranged below the first and second clusters 702a, 702b and includes eight elements 402 arranged in a two-by-four matrix. The cluster arrangement depicted in FIG. 7A is merely an example, and a RIS may be configured with alternative or additional clusters having alterative or additional element array or matrix arrangements.

In aspects, the different clusters may facilitate different channel conditions at the UE and/or BS. For example, the channel conditions between the first cluster 702a and the first UE 120a may be different from the channel conditions between the second cluster 702b and the first UE 120a. For purposes of key extraction, reflecting with different clusters may enable randomization of the key at the UE 120a and/or BS 110. As described herein with respect to the operations 500, the RIS may be configured to use specific elements 402 for reflecting the RSs used for key extraction. The elements 402 for reflection may be indicated at an element level (e.g., specific elements) and/or cluster level (e.g., specific clusters). For example, the RIS 114a may be configured to reflect the RSs using the first cluster 702a for communications between the BS 110 and the first UE 110a. Any reflections from the first cluster 702a received at an eavesdropper (such as the third UE 120c) will have encountered different channel properties, and thus, the received signals will have different amplitude and phase characteristics than the signals received at the first UE 120a and/or the BS 110. These different amplitude and phase characteristics will make it difficult for the eavesdropper to generate the key from the reflections or prevent the eavesdropper from generating the key.

In certain cases, multiple RISs may be employed during the key extraction phase. For example, the first and second RISs 114a, 114b may be used during the key extraction phase between the first UE 120a and the BS 110. In aspects, the RISs 114a, 114b may be used concurrently or in a sequence over time to reflect RSs between the first UE 120a and the BS 110, as further described herein. A particular RIS among a group of RISs employed during the key extraction may also be configured to use specific elements and/or a sequence of elements over time, as further described herein.

As shown, the BS 110 may communicate with the first UE 120a via the first RIS 114a, and in certain cases, the BS 110 may also communicate with the first UE 120a via the second RIS 114b. As an example, the first UE 120a may generate the key from RSs reflected off the first RIS 114a and/or the second RIS 114b. The first UE 120a may communicate with the second UE 120b via the first RIS 114b, and the second UE 120b may generate the key from RSs reflected off the first RIS 114a.

FIG. 7B is a diagram illustrating a sequence of clusters over time, in accordance with certain aspects of the present disclosure. In this example, the first cluster 702a may be used for reflecting RSs at a first transmission occasion T1; the third cluster 702c may be used for reflecting RSs at a second transmission occasion T2; and the second cluster 702b may be used for reflecting RSs at a third transmission occasion T3. The transmission occasions T1-T3 may be one or more symbols, segments of a slot (such as a mini-slot), slot, half-radio frame, or radio frame. In certain cases, the transmission occasions T1-T3 may be consecutive and/or non-consecutive time domain resources. That is, one or more time domain resources may be arranged between adjacent transmission occasions. Those of skill in the art will understand that the sequence illustrated in FIG. 7B is merely an example. Additional clusters, transmission occasions, or sequence arrangements may be used in addition to or instead of those illustrated. For example, multiple clusters may be used during a transmission occasion. In certain cases, the clusters may be arranged in the sequence from multiple RISs. In aspects, multiple precodings may be arranged across the sequence in addition to or instead of the clusters.

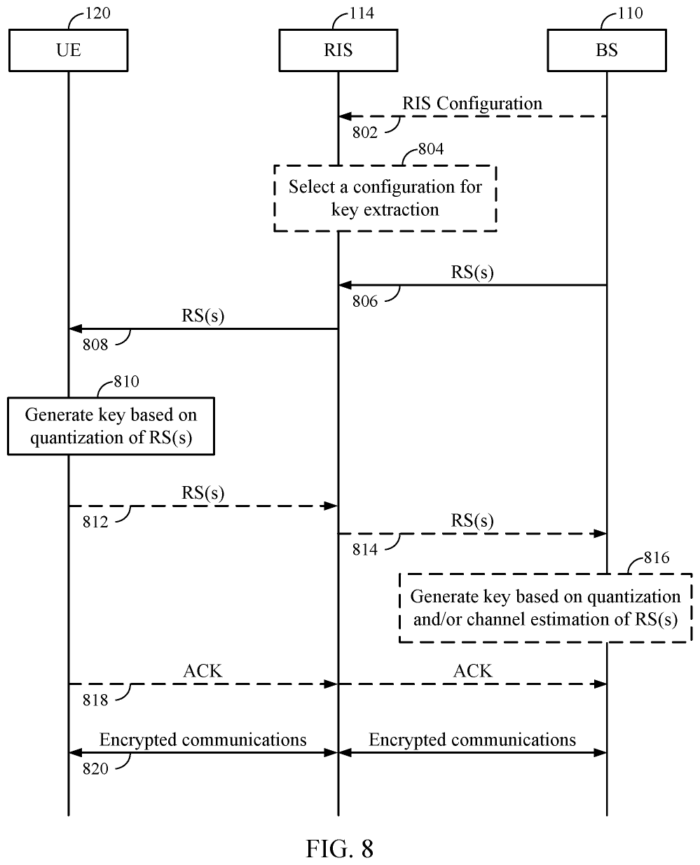

FIG. 8 is a signaling flow diagram illustrating example signaling for encryption key extraction, in accordance with certain aspects of the present disclosure. At 802, the BS 110 may configure the RIS 114 with one or more precodings, elements at the RIS, and/or a sequence of elements or precodings to use for the key extraction phase. At 804, a RIS controller may select the configuration for the RIS 114 in addition to or instead of the configuration received from the BS 110. At 806, the RIS 114 may receive one or more RSs from the BS 110, and at 808, the RIS 114 may reflect the RSs to the UE 120, for example, in accordance with the configuration(s) at 802 and/or 804. The UE 120 may perform one or more measurements on the received RSs, such as measuring the power, a channel quality indicator (CQI), a precoding matrix indicator (PMI), rank indicator (RI), a layer indicator, signal-to-noise ratio (SNR), signal-to-interference plus noise ratio (SINR), signal-to-noise plus distortion ratio (SNDR), a received signal strength indicator (RSSI), reference signal received power (RSRP), and/or reference signal received quality (RSRQ) associated with the received signals. In certain aspects, the UE 120 may report these measurements to the BS 110, for example, via uplink control information (UCI) to enable the BS 110 to estimate the downlink and uplink channels between the BS 110 and UE 120 through the RIS 114.

At 810, the UE 120 may generate a key based at least in part on a quantization of the RSs. For example, the UE 120 may use a specific level of quantization to transform the received signal into a string or number, and the string or number may serve as seed for a pseudorandom number generator, which may generate the key. In certain aspects, several iterations of quantization and/or several iterations of generating a random number may be performed to produce the key, which may be a public key (assuming the channel properties are already known to the BS) or a secret key.

At 812, the UE 120 may transmit one or more other RSs to the RIS 114, and at 814, the RIS 114 may reflect the other RSs to the BS 110 using the same configuration (e.g., precoding, elements, sequence of elements, and/or sequence of precodings) at 808.

At 816, the BS 110 may take measurements of the received signals, such as power, RSRP, RSRQ, and/or SINR. The BS 110 may generate a model of the BS-RIS-UE channel based on the received other RSs (assuming the transmit frequency, power and/or phase at the UE 120 at 812 are known to the BS 110) and/or UCI received from the UE 120. With the channel model, the BS 110 may derive the key obtained at the UE 120 at 810 based on the known frequency, power, and phase of the RSs transmitted by the BS 110 at 806. In certain cases, at 816, the BS 110 may generate a separate key (e.g., a public key or private key) based at least in part on the quantization of the other RSs, assuming the BS-RIS-UE channel is also known to the UE 120. In other words, if the BS-RIS-UE channel is known to the UE 120, the UE 120 may perform channel precoding on the other RSs to allow for the BS 110 to receive the key at a specific frequency, phase and/or amplitude that will enable the BS 110 to extract the key through quantization of the received signal.

At 818, the UE 120 may transmit an ACK message, which may be encrypted with the key generated at 810, to the RIS 114, and the RIS 114 may reflect the ACK message to the BS 110. The BS 110 may attempt to decrypt the ACK message with the key derived from the channel model at 816 or with a private key paired with a public key shared with the UE 120 at 808. If the BS 110 is successful at decrypting the ACK message, the BS 110 and UE 120 may communicate via encrypted communications as shown at 820. If the BS 110 decryption of the ACK message is unsuccessful, the BS 110 may reinitiate the process of sharing the encryption key with the UE 120. At 820, the BS 110 and UE 120 may communicate via encrypted messages with the shared key(s) through the RIS 114.

While the example depicted in FIG. 8 is described herein with respect to a BS sharing an encryption key with a UE to facilitate understanding, aspects of the present disclosure may also be applied to a UE sharing an encryption key with another UE, a UE configuring the RIS, and/or a UE initiating the key sharing operations instead of the BS.

In certain aspects, a hybrid encryption process may be employed in accordance with aspects of the present disclosure. For example, a first wireless node may share a public key with a second wireless node through a RIS using the techniques described herein, and then the second wireless node may share a secret key, which is encrypted by the public key, with the first wireless node using the techniques described herein. The first and second wireless nodes may then securely communicate with each other using the secret key.

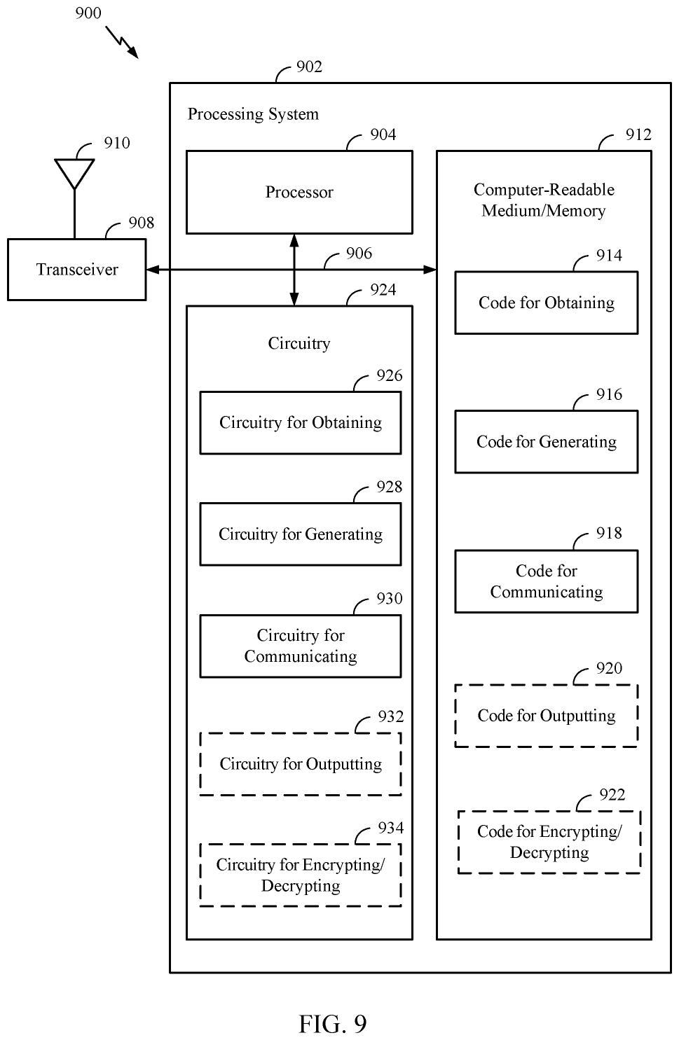

FIG. 9 illustrates a communications device 900 (e.g., a UE or BS) that may include various components (e.g., corresponding to means-plus-function components) configured to perform operations for the techniques disclosed herein, such as the operations illustrated in FIG. 5. The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals obtained or received and/or to be transmitted by the communications device 900.

The processing system 902 includes a processor 904 coupled to a computer-readable medium/memory 912 via a bus 906. In certain aspects, the computer-readable medium/memory 912 is configured to store instructions (e.g., computer-executable code) that when executed by the processor 904, cause the processor 904 to perform the operations illustrated in FIG. 5, or other operations for performing the various techniques discussed herein for encryption key extraction. In certain aspects, computer-readable medium/memory 912 stores code for obtaining 914, code for generating 916, code for communicating 918, code for outputting for transmission 920, and/or code for encrypting and/or decrypting 922. In certain aspects, the processing system 902 has circuitry 924 configured to implement the code stored in the computer-readable medium/memory 912. In certain aspects, the circuitry 924 is coupled to the processor 904 and/or the computer-readable medium/memory 912 via the bus 906. For example, the circuitry 924 includes circuitry for obtaining 924, circuitry for generating 928, circuitry for communicating 930, circuitry for outputting for transmission 932, and/or circuitry for encrypting and/or decrypting 934.

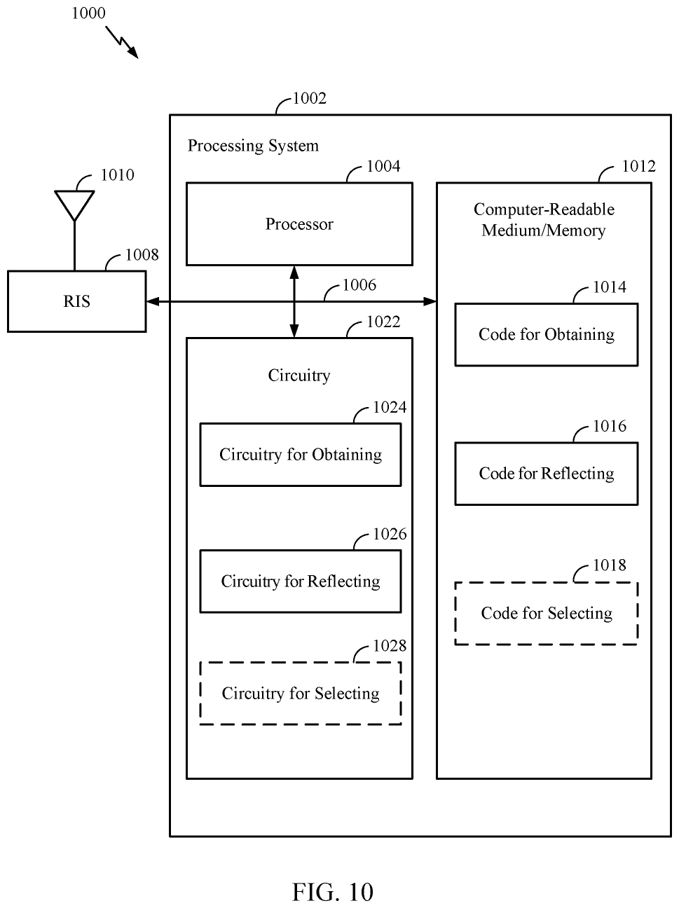

FIG. 10 illustrates a communications device 1000 (a RIS controller, BS, UE, and/or network controller) that may include various components (e.g., corresponding to means-plus-function components) configured to perform operations for the techniques disclosed herein, such as the operations illustrated in FIG. 6. The communications device 1000 includes a processing system 1002 coupled to a RIS 1008 (e.g., a reflectarray and/or metasurface). The RIS 1008 is configured to reflect and/or re-radiate signals for the communications device 1000 via an element 1010, such as the various signals as described herein. The processing system 1002 may be configured to perform processing functions (such as precoding and/or cluster selection) for the communications device 1000, including processing signals to be reflected and/or re-radiated by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 6, or other operations for performing the various techniques discussed herein for encryption key extraction. In certain aspects, computer-readable medium/memory 1012 stores code for obtaining 1014, code for reflecting 1016, and/or code for selecting 1018. In certain aspects, the processing system 1002 has circuitry 1022 configured to implement the code stored in the computer-readable medium/memory 1012. In certain aspects, the circuitry 1022 is coupled to the processor 1004 and/or the computer-readable medium/memory 1012 via the bus 1006. For example, the circuitry 1022 includes circuitry for obtaining 1024, circuitry for reflecting 1026, and/or circuitry for selecting 1028.

### Example Aspects

In addition to the various aspects described above, specific combinations of aspects are within the scope of the disclosure, some of which are detailed below:

Aspect 1: A method of wireless communications by a first wireless node, comprising: receiving one or more first reference signals (RSs) as reflections off a reconfigurable intelligent surface (RIS) from a second wireless node; generating a key based at least in part on a quantization of the one or more first RSs; and communicating, based on the key, with the second wireless node.

Aspect 2: The method according to any of Aspects 1, further comprising transmitting, to the second wireless node, one or more second RSs as reflections off of the RIS.

Aspect 3: The method according to any of Aspects 1-2, further comprising transmitting, to a controller associated with the RIS, an indication of one or more elements at the RIS to use for reflecting at least one of the one or more first RSs or the one or more second RSs.

Aspect 4: The method of Aspect 3, wherein the indication further indicates to use the one or more elements at the RIS with one or more channels.

Aspect 5: The method according to any of Aspects 1-4, wherein receiving the one or more first RSs comprises receiving the one or more first RSs based on a first precoding applied at the RIS.

Aspect 6: The method according to any of Aspects 2 and 5, wherein transmitting the one or more second RSs comprises transmitting the one or more second RSs based on a second precoding applied at the RIS.

Aspect 7: The method according to any of Aspects 5-6, wherein at least one of the first precoding or the second precoding is selected by a controller associated with the RIS.

Aspect 8: The method of Aspect 2, further comprising transmitting, to a controller associated with the RIS, an indication of a sequence of elements at the RIS to use over time for reflecting at least one of the one or more first RSs or the one or more second RSs.

Aspect 9: The method of Aspect 8, wherein the sequence of elements includes a sequence of element clusters to use over time at a symbol level, wherein each of the element clusters comprises a plurality of elements at the RIS.

Aspect 10: The method according to any of Aspects 2-4 and 8-9, further comprising transmitting, to a controller associated with the RIS, an indication of a precoding to use at the RIS for reflecting at least one of the one or more first RSs or the one or more second RSs.

Aspect 11: The method according to any of Aspects 3, 8, and 9, wherein the indication includes a bitmap associated with the elements at the RIS, wherein the bitmap indicates which elements are enabled for reflecting.

Aspect 12: The method of Aspect 11, wherein the bitmap further indicates which elements are enabled in one or two dimensions across the RIS.

Aspect 13: The method according to any of Aspects 1-12, further comprising communicating, before generating the key, with the second wireless node via one or more messages encrypted with another key.

Aspect 14: The method of Aspect 13, wherein the one or more messages include at least one of an indication of elements at the RIS that will be used for reflecting or a level of quantization for generating the key.

Aspect 15: The method according to any of Aspects 1-14, wherein the RIS comprises a plurality of RISs.

Aspect 16: The method of Aspect 15, wherein receiving the one or more first RSs comprises receiving the one or more first RSs as the reflections reflected off the plurality of RISs.

Aspect 17: The method according to any of Aspects 15-16, wherein transmitting the one or more second RSs comprises transmitting the one or more second RSs as reflections off the plurality of RISs.

Aspect 18: The method according to any of Aspects 1-17, further comprising transmitting, to the second wireless node, an acknowledgement encrypted with the key.

Aspect 19: The method according to any of Aspects 1-18, wherein generating the key comprises generating the key with a random number generator, and a seed for the random number generator includes the quantization.

Aspect 20: The method according to any of Aspects 1-19, wherein communicating with the second wireless node comprises: encrypting one or more messages with the key; and outputting, for transmission to the second wireless node, the encrypted one or more messages.

Aspect 21: The method according to any of Aspects 1-20, wherein communicating with the second wireless node comprises: obtaining, from the second wireless node, one or more messages; and decrypting the one or more messages with the key or another key associated with the key.

Aspect 22: The method according to any of Aspects 20-21, wherein the one or more messages include at least one of downlink control information, uplink control information, or sidelink control information.

Aspect 23: The method according to any of Aspects 1-23, wherein communicating with the second wireless node comprises encrypting at least one of a downlink channel, an uplink channel, or a sidelink channel with the key.

Aspect 24: A method of wireless communications by a network entity, comprising: receiving one or more reference signals (RSs) indicative of a key from a first wireless node; reflecting the one or more RSs with one or more elements at a reconfigurable intelligent surface (RIS) to a second wireless node; and reflecting one or more messages encrypted with the key between the first wireless node and the second wireless node.

Aspect 25: The method of Aspect 24, further comprising receiving, from the first wireless node or the second wireless node, an indication of the one or more elements at the RIS to use for reflecting the one or more RSs.

Aspect 26: The method of Aspect 25, wherein the indication further indicates to use the one or more elements at the RIS with one or more channels.

Aspect 27: The method according to any of Aspects 24-26, further comprising: selecting a precoding for the reflection of the one or more RSs; and wherein reflecting the one or more RSs comprises reflecting the one or more RSs based on the selected precoding.

Aspect 28: The method according to any of Aspects 24-27, further comprising: receiving, from the first wireless node or the second wireless node, an indication of a sequence of elements at the RIS to use over time for reflecting the one or more RSs; and wherein reflecting the one or more RSs comprises reflecting the one or more RSs according to the sequence of elements at the RIS.

Aspect 29: The method of Aspect 28, wherein the sequence of elements includes a sequence of element clusters to use over time at a symbol level, wherein each of the element clusters comprises a plurality of elements at the RIS.

Aspect 30: The method according to any of Aspects 24-29, further comprising receiving, from the first wireless node or the second wireless node, an indication of a precoding to use at the RIS for reflecting the one or more RSs.

Aspect 31: The method according to any of Aspects 25, 28, and 29, wherein the indication includes a bitmap associated with the elements at the RIS, wherein the bitmap indicates which elements are enabled for reflecting.

Aspect 32: The method of Aspect 31, wherein the bitmap further indicates which elements are enabled in one or two dimensions across the RIS.

Aspect 33: The method according to any of Aspects 24-32, wherein the RIS comprises a plurality of RISs.

Aspect 34: The method of Aspect 33, wherein receiving the one or more RSs comprises receiving the one or more RSs at the plurality of RISs.

Aspect 35: The method according to any of Aspects 33-34, wherein reflecting the one or more RSs comprises reflecting the one or more RSs with the one or more elements at the plurality of RISs.

Aspect 36: A first wireless node, comprising means for performing the operations of one or more of Aspects 1-23.

Aspect 37: A first wireless node, comprising a transceiver and processing system including at least one processor configured to perform the operations of one or more of Aspects 1-23.

Aspect 38: An apparatus for wireless communications by a first wireless node, comprising: an interface configured to obtain one or more first reference signals (RSs) as reflections off a reconfigurable intelligent surface (RIS) from a second wireless node; and a processing system configured to generate a key based at least in part on a quantization of the one or more first RSs and communicate, based on the key, with the second wireless node.

Aspect 39: A computer-readable medium for wireless communications, comprising codes executable by a first wireless node to perform the operations of one or more of Aspects 1-23.

Aspect 40: A network entity, comprising means for performing the operations of one or more of Aspects 24-35.

Aspect 41: A network entity, comprising a transceiver and processing system including at least one processor configured to perform the operations of one or more of Aspects 24-35.

Aspect 42: An apparatus for wireless communications by a network entity, comprising: an interface configured to obtain one or more reference signals (RSs) indicative of a key from a first wireless node; and a processing system configured to reflect the one or more RSs with one or more elements at a reconfigurable intelligent surface (RIS) to a second wireless node and reflect one or more messages encrypted with the key between the first wireless node and the second wireless node.

Aspect 43: A computer-readable medium for wireless communications, comprising codes executable by a first wireless node to perform the operations of one or more of Aspects 24-35.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another. In other words, unless a specific order of steps or actions is specified, the order and/or use of specific steps and/or actions may be modified.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor). Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above can also be considered as examples of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 5 and/or FIG. 6.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above.

1. A method of wireless communications by a first wireless node, comprising:
receiving one or more first reference signals (RSs) as reflections off a reconfigurable intelligent surface (RIS) from a second wireless node;
generating a key based at least in part on a quantization of the one or more first RSs; and
communicating, based on the key, with the second wireless node.

2. The method of claim 1, further comprising transmitting, to the second wireless node, one or more second RSs as reflections off of the RIS.

3. The method of claim 2, further comprising transmitting, to a controller associated with the RIS, an indication of one or more elements at the RIS to use for reflecting at least one of the one or more first RSs or the one or more second RSs.

4. The method of claim 3, wherein the indication further indicates to use the one or more elements at the RIS with one or more channels.

5. The method of claim 1, wherein receiving the one or more first RSs comprises receiving the one or more first RSs based on a first precoding applied at the RIS.

6. The method of claim 5, wherein transmitting the one or more second RSs comprises transmitting the one or more second RSs based on a second precoding applied at the RIS.

7. The method of claim 6, wherein at least one of the first precoding or the second precoding is selected by a controller associated with the RIS.

8. The method of claim 2, further comprising transmitting, to a controller associated with the RIS, an indication of a sequence of elements at the RIS to use over time for reflecting at least one of the one or more first RSs or the one or more second RSs.

9. The method of claim 8, wherein the sequence of elements includes a sequence of element clusters to use over time at a symbol level, wherein each of the element clusters comprises a plurality of elements at the RIS.

10. The method of claim 2, further comprising transmitting, to a controller associated with the RIS, an indication of a precoding to use at the RIS for reflecting at least one of the one or more first RSs or the one or more second RSs.

11. The method of claim 3, wherein the indication includes a bitmap associated with the elements at the RIS, wherein the bitmap indicates which elements are enabled for reflecting.

12. The method of claim 11, wherein the bitmap further indicates which elements are enabled in one or two dimensions across the RIS.

13. The method of claim 1, further comprising communicating, before generating the key, with the second wireless node via one or more messages encrypted with another key.

14. The method of claim 13, wherein the one or more messages include at least one of an indication of elements at the RIS that will be used for reflecting or a level of quantization for generating the key.

15. The method of claim 1, wherein, at last one of:
the RIS comprises a plurality of RISs;
receiving the one or more first RSs comprises receiving the one or more first RSs as the reflections reflected off the plurality of RISs; or
transmitting the one or more second RSs comprises transmitting the one or more second RSs as reflections off the plurality of RISs.

16. The method of claim 1, further comprising transmitting, to the second wireless node, an acknowledgement encrypted with the key.

17. The method of claim 1, wherein generating the key comprises generating the key with a random number generator, and a seed for the random number generator includes the quantization.

18. The method of claim 1, wherein, at least one of:
communicating with the second wireless node comprises encrypting one or more first messages with the key and outputting, for transmission to the second wireless node, the encrypted one or more messages;
communicating with the second wireless node comprises obtaining, from the second wireless node, one or more second messages and decrypting the one or more second messages with the key or another key associated with the key; or
the one or more first or second messages include at least one of downlink control information, uplink control information, or sidelink control information.

19. The method of claim 1, wherein communicating with the second wireless node comprises encrypting at least one of a downlink channel, an uplink channel, or a sidelink channel with the key.

20. A method of wireless communications by a network entity, comprising:
receiving one or more reference signals (RSs) indicative of a key from a first wireless node;
reflecting the one or more RSs with one or more elements at a reconfigurable intelligent surface (RIS) to a second wireless node; and
reflecting one or more messages encrypted with the key between the first wireless node and the second wireless node.

21. The method of claim 20, further comprising receiving, from the first wireless node or the second wireless node, an indication of the one or more elements at the RIS to use for reflecting the one or more RSs.

22. The method of claim 21, wherein the indication further indicates to use the one or more elements at the RIS with one or more channels.

23. The method of claim 20, further comprising:
selecting a precoding for the reflection of the one or more RSs;
wherein reflecting the one or more RSs comprises reflecting the one or more RSs based on the selected precoding.

24. The method of claim 20, further comprising:
receiving, from the first wireless node or the second wireless node, an indication of a sequence of elements at the RIS to use over time for reflecting the one or more RSs; and
wherein reflecting the one or more RSs comprises reflecting the one or more RSs according to the sequence of elements at the RIS.

25. The method of claim 24, wherein the sequence of elements includes a sequence of element clusters to use over time at a symbol level, wherein each of the element clusters comprises a plurality of elements at the RIS.

26. The method of claim 20, further comprising receiving, from the first wireless node or the second wireless node, an indication of a precoding to use at the RIS for reflecting the one or more RSs.

27. The method of claim 21, wherein the indication includes a bitmap associated with the elements at the RIS, wherein the bitmap indicates which elements are enabled for reflecting.

28. The method of claim 27, wherein the bitmap further indicates which elements are enabled in one or two dimensions across the RIS.

29. The method of claim 20, wherein, at least one of:
the RIS comprises a plurality of RISs;
receiving the one or more RSs comprises receiving the one or more RSs at the plurality of RISs; or
reflecting the one or more RSs comprises reflecting the one or more RSs with the one or more elements at the plurality of RISs.

30. An apparatus for wireless communications by a first wireless node, comprising:
an interface configured to obtain one or more first reference signals (RSs) as reflections off a reconfigurable intelligent surface (RIS) from a second wireless node; and
a processing system configured to:
generate a key based at least in part on a quantization of the one or more first RSs; and
communicate, based on the key, with the second wireless node.
